(19) United States
(12) Patent Application Publication
(10) Pub. No.: US 2012/0137498 A1
(43) Pub. Date: Jun. 7, 2012

(54) Hot Forming with Inlay Material

(75) Inventors: Franz-Josef Lenze, Lennestadt (DE); Sascha Sikora, Lunen (DE); Harald Hofmann, Dortmund (DE); Ralf Kolleck, Graz (AT); Robert Veit, Graz (AT)

(73) Assignee: ThyssenKrupp Steel Europe AG, Duisburg (DE)

(21) Appl. No.: 13/310,058

(22) Filed: Dec. 2, 2011

Related U.S. Application Data
(63) Continuation of application No. PCT/EP2010/057551, filed on May 31, 2010.

(30) Foreign Application Priority Data
Jun. 3, 2009 (DE) 102009025896.5

(51) Int. Cl. B23P 19/04

(52) U.S. Cl. 29/460; 29/283.5

(57) ABSTRACT

The invention relates to a method for hot forming a blank consisting of an aluminium or steel alloy, in which the blank is heated before forming and subsequently formed in a forming tool at a temperature of at least 150° C., and to a device for carrying out the hot forming, having a forming tool which has a punch and a die. The object of proposing an economic method for hot forming is achieved for hot forming an aluminium or steel blank by placing an insulating material onto at least one surface of the blank before forming, wherein the insulating material has a lower thermal conductivity than the blank and the forming takes place with the applied insulating material.

### CROSS-REFERENCE TO RELATED PATENT APPLICATIONS

This patent application is a continuation of PCT/EP2010/057551, filed May 31, 2010, which claims priority to German Application No. 102009025896.5, filed Jun. 3, 2009, the entire teachings and disclosure of which are incorporated herein by reference thereto.

### FIELD OF THE INVENTION

The invention relates to a method for hot forming a blank consisting of an aluminium or steel alloy, in which the blank is heated before forming and subsequently formed in a forming tool at a temperature of at least 150° C., and to a device for carrying out the hot forming, having a forming tool which has a punch and a die.

### BACKGROUND OF THE INVENTION

Steel is mostly used as the material for manufacturing motor vehicles and their bodies. The requirements for reducing the weight of the vehicle body are accommodated by the development of high-strength steels. With these steels or steel alloys, the sheet thicknesses can be further reduced, so that the total weight of the vehicle bodies drops. However, due to the high strengths of these steel alloys, the forming forces during manufacture of components, for example deep-drawn parts, become particularly great. Therefore, high-strength steels are preferably formed by a hot forming process, in order to reduce forming forces and obtain the required degrees of deformation. In hot forming and press hardening, the blank is firstly heated to austenitisation temperature A₃ or to a higher temperature. The blank is then inserted hot, i.e. at a temperature of more than 650°, into the forming tool and intensely cooled during forming. The blank must, however, not be cooled too intensely during the forming process, in order to prevent the martensite start temperature from already being reached in the component before the component has been fully formed, i.e. before the forming process has been completed. This namely results in premature hardening of the blank material occurring, which can lead to cracks in the component and hence to rejected blanks. When the forming process of the blank has ended, cooling should take place very quickly, so that the component can be hardened sufficiently. Although tools brought to a high temperature, in which the blanks can be held for a long time at forming temperature, prevent crack formation they cannot, due to their high temperature, achieve sufficiently high cooling rates for the blank after forming has been completed, so that hardening cannot be sufficient. In addition, the costs of purchasing these tools are high.

Improved degrees of deformation with hot forming are also known for blanks consisting of aluminium alloys. Higher degrees of deformation are, however, already obtained from a blank temperature of 150°.

### SUMMARY OF THE INVENTION

Starting from this point, the invention is based on the object of proposing an economic method for hot forming blanks consisting of an aluminium or steel alloy, in which, on the one hand, a sufficiently high temperature for the duration of the forming process of the blank is ensured and, at the same time, sufficiently quick cooling of the blank after the forming process has been completed is ensured.

The above disclosed object is achieved according to a first teaching of the present invention by placing an insulating material on at least one surface of the blank before forming, wherein the insulating material has a lower thermal conductivity than the blank and the forming takes place with the applied insulating material.

It has been shown that by using an insulating material, the process of cooling the blank in the forming tool can be considerably slowed down, so that the process of forming the component can be reliably carried out without cracks occurring in the heavily deformed areas. The forming tool does not then have to be brought to a very high temperature and is, therefore, cost-efficient. The insulating material provides an economically simple alternative for preventing cracks in components during hot forming. Warm forming the corresponding alloy is also covered according to the invention under the term hot forming.

According to a first preferred embodiment of the method according to the invention, a blank consisting of a steel alloy is heated to austenitisation temperature and subsequently formed in a forming tool at a temperature of at least 650° C. By heating to the austenitisation temperature, the blank consisting of a steel alloy has an austenitic structure and hence is in a state which is easily deformable. Subsequently, very high strengths can be obtained in a reliable way in terms of the process, owing to the transformation of the austenitic structure into a martensitic structure during cooling.

According to a further advantageous embodiment of the method according to the invention, an insulating material is used whose thermal conductivity increases or remains the same during the forming. It is hereby ensured that at the start of forming the component, owing to a thermal conductivity which is as low as possible, the heat loss of the blank is particularly low during forming and the blank is held for a long time at forming temperature. If the thermal conductivity of the insulating material increases during the forming, it is, at the same time, ensured that the cooling rate of the blank is sufficient to harden the blank after the forming process has ended. Preferably, the thermal conductivity of the insulating material increases by at least a factor of 10.

If an inlay material is used as the insulating material, which is placed on the blank in the forming tool, the insulating material can be handled particularly easily. Inlaying the insulating material can be simply automated. Of course, it is also possible to place the inlay material on the blank beforehand and to insert the blank in conjunction with the inlay material into the forming tool.

According to a further advantageous embodiment of the method according to the invention, paper or cardboard is used as the insulating material. It has been shown that paper or cardboard at the start of the forming process has a very low thermal conductivity of about 0.05 W/Mk and therefore has a very good insulating effect. During forming in the closed forming tool, the paper or cardboard becomes charred, so that the coefficient of thermal conduction considerably changes to 1.7 W/Mk. Paper with a grammage of 250 g/m² has produced good results in the tests. This also applies for cardboard which has a grammage of more than 600 g/m².

In order to devise the hot forming process in a way which in terms of the procedure is particularly simple, according to a subsequent embodiment of the method according to the invention, the insulating material is fed in the form of a strip to the forming tool or is inserted as a pre-cut part into the forming tool. When feeding the insulating material in the form of a strip, the width of the strip, for example, can be greater than the width of the blank, so that the insulating material can be easily fed to and easily carried away from the forming tool. Furthermore, the greater width of the insulating material also provides the possibility when fed in the form of a strip of removing the insulating material again from the forming tool after the forming process has ended. The strip edges which remain with the greater width after the blank has been formed enable the used insulating material to be carried away and new insulating material to be fed.

In order to prevent the insulating material from catching fire, before the closing position of the forming tool is reached, the insulating material can contain flame-retardant substances or can be coated with them. Cardboard coated with flame-retardant materials in use produced particularly good results with regard to preventing the insulating material from catching fire, wherein charring in the tool, and hence the change in the coefficient of thermal conduction, nevertheless took place. In addition, closing the forming tool very quickly also prevents the insulating material from catching fire.

Furthermore, the inlay material is preferably used as a carrier material for functional substances and the functional substances interact with the blank or the blank surface during forming. It is conceivable, for example, to apply coatings which are produced on the blank surface due to the high temperature and high pressure.

Finally, an advantageous embodiment of the method according to the invention involves the blank consisting of a steel alloy being press-hardened at least in sections during hot forming. Press-hardened component areas have very high strength values due to the consistently martensitic microstructure.

According to a second teaching of the present invention, the above disclosed object is achieved using a device for carrying out the forming method according to the invention, having a forming tool which has a punch and a die, by providing means for placing insulating material as inlay material on and/or under the blank to be formed. Handling systems, which inlay the inlay parts automatically into the forming tool with the blank, are for example suitable as means for inlaying the inlay parts consisting of insulating material. These enable the method according to the invention to be carried out particularly economically.

A further increase in automation can be achieved by providing means to feed insulating material, in particular paper or cardboard, in the form of a strip to the forming tool. Instead of the single feed for the insulating material, the method according to the invention can be further simplified by feeding the insulating material in the form of a strip using coilers and decoilers.

### BRIEF DESCRIPTION OF THE DRAWINGS

There are now many possibilities for further configuring and developing the method according to the invention and the device according to the invention. Reference is made, in this regard, to the claims subordinate to claims 1 and 9, on the one hand, as well as to the description of an exemplary embodiment in conjunction with the drawing. In the drawing:

FIG. 1 shows, in a schematic view, an exemplary embodiment of a device according to the invention for carrying out the method.

### DETAILED DESCRIPTION OF THE INVENTION

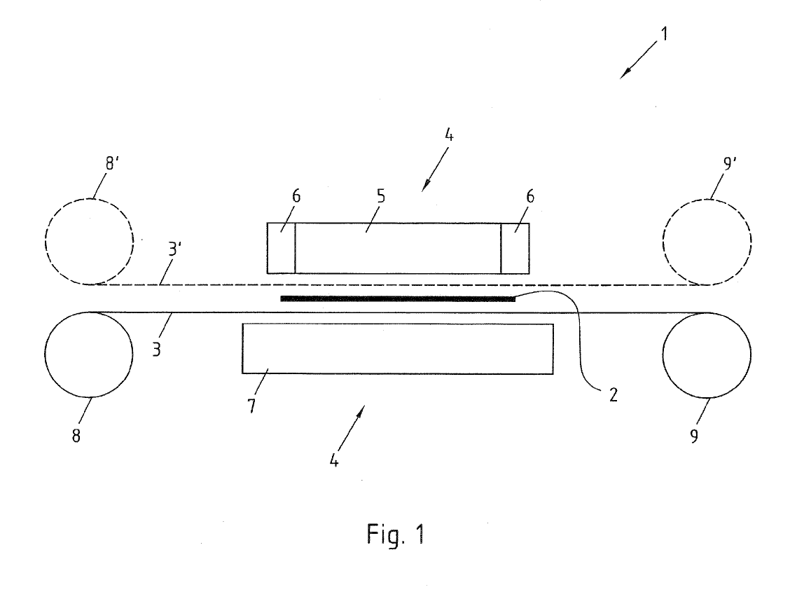

FIG. 1 shows a device 1 according to the invention for carrying out the hot forming of a blank 2, while at the same time feeding an insulating material 3 which is formed at the same time with the blank 2 in the forming tool 4. An Mn22B5 steel can, for example, be used as the blank material. However, the use of other steel alloys which are hot formed is also possible. The forming tool 4 consists, for example, of a punch 5, two holding-down devices 6 and a die 7. The insulating material 3 is placed under the blank in the forming tool and is fed in the form of a strip. For this purpose, a decoiler 8 and a coiler 9 are provided as means for feeding the insulating material in the form of a strip. In order to cover the blank 2 with insulating material on both sides, further means are additionally provided for feeding 8′, 9′ in the form of a strip, which feed the additional insulating material 3′ to the forming tool and coil it up again.

The blank 2, heated for example to temperatures of about 820° C. to 950° C., is inserted into the forming tool 4, wherein insulating material 3, 3′, in the form of paper or cardboard, is placed on both blank surfaces. As already explained previously, cardboard has a coefficient of thermal conduction of about 0.05 W/mK. However, during forming and charring of the cardboard due to the high temperatures of the blank, the coefficient of thermal conduction increases rapidly from 0.05 W/mK to 1.7 W/mK.

FIG. 1 does not illustrate that the blank 2 is formed with the applied insulating material 3, 3′. In the first forming phase, in which the inlaid insulating material 3, 3′ still has a full insulating effect, the temperature of the blank 2 is not greatly lowered, so that the blank can be fully formed at hot forming temperature. After the cardboard chars, a greater transfer of heat takes place from the blank to the forming tool, so that the cooling rates required for martensite to form reach more than 27 K/s to enable hardening to take place.

1. Method for hot forming a blank consisting of an aluminium or steel alloy, in which the blank is heated before forming and subsequently formed in a forming tool at a temperature of at least 150° C., comprising:
placing an insulating material onto at least one surface of the blank before forming, wherein the insulating material has a lower thermal conductivity than the blank, wherein the forming takes place with the applied insulating material and wherein an inlay material is used as the insulating material which is placed on the blank in the forming tool.

2. Method according to claim 1, wherein a blank consisting of a steel alloy is heated to austenitisation temperature and subsequently formed in a forming tool at a temperature of at least 650° C.

3. Method according to claim 1, wherein an insulating material is used whose thermal conductivity increases or remains the same during the forming.

4. Method according to claim 1, wherein paper or cardboard is used as the insulating material.

5. Method according to claim 1, wherein the insulating material is fed in the form of a strip to the forming tool or is inserted as a pre-cut part into the forming tool.

6. Method according to claim 1, wherein the insulating material contains flame-retardant substances or is coated with them.

7. Method according to claim 1, wherein the inlay material is used as a carrier material for functional substances and the functional substances interact with the blank surface or the blank during forming.

8. Method according to claim 1, wherein the blank is press-hardened at least in sections during hot forming.

9. Device for carrying out a method according to claim 1, the device comprising:
a forming tool which has a punch and a die; and
a means for placing insulating material as inlay material on at least one surface of the blank to be formed.

10. Device according to claim 9, wherein the means for placing is operative to feed insulating material in the form of a strip to the forming tool.
